(19) United States
(12) Patent Application Publication
(10) Pub. No.: US 2007/0055583 A1
(43) Pub. Date: Mar. 8, 2007

(54) Media package system

(76) Inventor: Barbara Nell Davis, Brookhaven, MS (US)

Correspondence Address: TERRY B. MORRIS, P.O. BOX 808, PASS CHRISTIAN, MS, 39571-0808, US

(21) Appl. No.: 11/180,827

(22) Filed: Jul. 12, 2005

(51) Int. Cl. G06Q 10/00

(52) U.S. Cl. 705/28

(57) ABSTRACT

The present invention is a point-of-purchase system for selecting a presentation material set. This system solves the problem for the casual consumer or professional business manager in selecting a combination of media components wherein the provided selection system has a skilled judgment associated with the selection. The system is the means for displaying two or more different package groups which are selected from a larger group. Using coded symbols, the user is guided to selection materials using a variety of design preferences.

### BACKGROUND OF THE INVENTION

1. Field of the Invention

The subject invention relates to presentation media and, more particularly, to a system of competently matching different components of a media package.

2. Description of the Related Art

Technology is driving the presentation media market into a virtual home based world of entrepreneurs and small businesses. That has created a niche that is increasing daily and has yet to be met. They face challenges including limited budgets, limited resources, and limited time all in the face of competing with larger companies that can afford to hire professionals to produce presentations that the small company cannot compete with. Even within large corporations, divisions who may be developing brilliant new products or ideas may share the same challenges in marketing. Currently, there are several available avenues that a business has in which to obtain presentation materials. They include Graphic Designers, Advertising Agencies, Printing Companies, Specialty Copy Center Stores.

Presently, Office Supply Stores, Office Supply Super Stores, Catalog Companies and Specialty Copy Center Stores do not offer a professional mix and match system for coordinating text and cover stocks for a professional presentation, nor do they offer on-site professional graphic designers to produce quality presentation materials. The current offering of professional presentation materials is poor and limited, unorganized and inconvenient for the consumer, and offers no mix and match system or professional design support.

While Graphic Designers, Advertising Agencies, Printing Companies can provide the design support, the disadvantages of using them include cost restraints, quantity or volume issues, inconvenience, and unknown outcome.

An alternative is the self-purchase of the presentation materials by the consumer or business user. To obtain the individual, non-professionally matched components for such presentations, the user can exercise non-guided purchasing opportunities through the following avenues: Office Supply Stores, Office Supply Super Stores, Catalog Companies, Graphic Designers, Advertising Agencies, Printing Companies, and Specialty Copy Center Stores. All of these sources may use the internet in which to market their products. Such is problematic in that the material characteristic, such as color or texture, is not reliably discernable through the internet.

Office Supply Stores have disadvantages. One is that the customer has to order from a catalog and does not always know what they are getting. The consumer has less of a chance here to achieve professional presentation selections (than the super stores who carry the same selections in store) because catalog printers cannot capture correct color and texture. Therefore, the consumer is taking a risk even making a selection. If a customer does not like the selection and want to change it, they will usually be charged a restocking fee to send it back for another selection. Such potential of restocking charges translate into higher cost. The choices in such catalogs are typically poor and limited choices; and the time for delivery is slow, but not as much as using a graphic designer, ad agency or printing company.

Office Supply Super Stores and Specialty Copy Center Stores likewise have disadvantages. These stores tend to be inconvenient. For instance, text and cover stocks are in different areas of the store. There is no system of direction on mixing text and cover stocks for a professional presentation except from untrained employees. If they have a copy center, such tend to be staffed with unskilled or inconsistently trained employees, not at the standard of a graphic designer with a degree. The merchandise offered are poor and limited choices.

Catalog Companies and Online Companies are similarly disadvantageous. As stated above, catalog printers cannot capture correct color and texture. Therefore, the consumer is taking a risk even making a selection with all the disadvantages of the Office Supply Stores. There is no mixing system to assist the consumer or business user on making design choices.

Graphic Designers also have disadvantages. Such professionals will often be expensive and can eat up a small business's marketing budget quickly with one presentation. They also tend to be inconvenient. The search for the right graphic designer can be challenging. Once one is found, the end result is unpredictable and takes longer. Such services also typically require high quantity minimums (for per piece cost control). The results might be customized and have the advantage of flexibility.

Advertising Agencies and Printing Companies also have disadvantages. They are expensive and can exhaust a small business's marketing budget quickly with one presentation. Among the inconveniences, the search for the right agency or printing company with competent graphic designers can be challenging. Once one is found, the end result is unpredictable and takes longer. Such services also typically require high quantity minimums (for per piece cost control). There might be an advantage in having more flexibility on how the presentation is customized.

A critical characteristic to obtain a professional quality result is missing through these sources. What is needed is a system of methodology and products which affords the consumer or business person the capability to professionally design and produce the media material for a presentation activity; e. g., a mix and match system. The present invention solves this need.

One object of the present invention is a mix and match system which provides professional design and advice for creating a custom presentation with variable uses; small quantities or quantities that work within a company's budget and usage requirements; attractive, professional selections that provide sure proof professional presentation solutions; no time restraints and no inconvenience.

Another objective is to create a mix and match system which opens a new and broadened market for dark textured cover stocks and stationary stock that will increase the selling potential of those items for paper manufacturer(s).

### SUMMARY

The present invention is a point-of-purchase system for selecting a presentation material set. This system solves the problem for the casual consumer or professional business manager in selecting a combination of media components wherein the provided selection system has a skilled judgment associated with the selection. The system is the means for displaying two or more different package groups which are selected from a larger group. This larger group comprises—
(1) a package group of one or more binder cover stock package(s),
(2) a package group of one or more pocket folder package(s),
(3) a package group of one or more text stock package(s) selected from companion stock package(s) and stationary package(s),
(4) a package group of one or more envelope package(s) selected from standard envelope packages and customized packages, and
(5) a package group of one or more label package(s) selected from standard label packages and customized label packages. In the practice of the present invention at least one of the package groups comprises a selection of packages in which respective media character of the contents differs. Each of the packages is associated with a code which enables the designer coordination of the media character of the content of such package with the media character of the content of another package. By the use of this system of coded selection, the benefit of having a “virtual” media professional at the point of sale is provided to skillfully mix and match among the selection provided.

### DESCRIPTION OF THE DRAWINGS

FIG. 1 depicts a cover front page of a package of companion stock paper for use in an embodiment of the present invention.

FIG. 2 depicts the bin layout arrangement of one side of a kiosk using the present invention selling presentation materials, including packages of materials referred to in FIG. 1.

FIG. 3 depicts the bin layout arrangement of another side of the same kiosk referred to in FIG. 2 using the present invention selling presentation materials, but not including packages of materials referred to in FIG. 1.

### DESCRIPTIONS OF THE PREFERRED EMBODIMENT

One embodiment of the present invention is a point-of-purchase system for selecting a presentation material set. The system is the means for displaying two or more different package group of materials which are selected from a group. This group comprises (1) a package group of one or more binder cover stock package(s), (2) a package group of one or more pocket folder package(s), (3) a package group of one or more text stock package(s) selected from companion stock package(s) and stationary package(s), (4) a package group of one or more envelope package(s) selected from standard envelope packages and customized envelope packages, and (5) a package group of one or more label package(s) selected from standard label packages and customized label packages. While these are representative, other groups of materials usable for presentations may be used as well. In the practice of the present invention at least one of the package groups comprises a selection of packages which respective media character of the contents differs. Each of the packages is associated with a code which enables the designer coordination of the media character of the content of such package with the media character of the content of another package.

In a preferred embodiment, in the present inventive system, the media character comprises color, dimension, weight and/or texture of the material used.

In another preferred embodiment, in the present inventive system, the media character comprises grid-set values to align a window, a label, an embossment, and/or a die-cut.

In yet another preferred embodiment, in the present inventive system, the coordination of media character provides a variation within professional limits in the media character of selected packages.

In another preferred embodiment, in the present inventive system, the media character is printability.

Another embodiment of the present invention is a method of creating a guide to the selection of a set of products. The method comprises displaying two or more different package groups selected from a group comprising (1) a package group of one or more binder cover stock package(s), (2) a package group of one or more pocket folder package(s), (3) a package group of one or more text stock package(s) selected from companion stock package(s) and stationary package(s), (4) a package group of one or more envelope package(s) selected from standard envelope packages and customized packages, and (5) a package group of one or more label package(s) selected from standard label packages and customized label packages. In the practice of the present invention at least one of said package groups comprises a selection of individual packages which respective media character of the contents differ from that of other individual packages within the package group.

Each package of the packages is associated with a code which enables the designer coordination of the media character of the content of such package with the media character of the content of another package. The method further involves providing a code associated with each of said package and selecting two or more of said packages in accord with provided instructions for matching the respective codes on each selected package to coordinate the media characters of the contents of the selected package(s). Preferably, the coded material is encoded to enable the mixing and matching of media materials pursuant to a skilled, professional judgment. The code can be manifested by symbols, bar codes, colors, shapes or any other information manifestation. The user of the code is instructed by packaging text, charts or other explanations or prompts. Instruction may also be present in some format at the point of sale or secondary sources, such as advertisements, instruction sheets or manuals.

One non-limiting example of an embodiment of the present invention is a system provided in an office supply store in the form of a kiosk. The kiosk has several bins in which there are available a variety of media components; i. e., binders, folders, text stock sheets, business card stock and envelopes. Each of the components come in a variety of distinctive selections, differing in colors, paper weight and paper components (such as differing paper finishes, contents etc.). The packaging for each bears one or more unique code symbol(s) in the form of a colored shape, such as red or green squares or circles. By reference to a chart accompanying the kiosk, the user can determine the recommended selections which will result in a desirable mix and match.

Examples of the practice of the present invention are in the following descriptions of two commercial kiosk displays, such as one might find in a shopping center or mall:

### Display Kiosk 1

A display kiosk supports stacks of packages of frame embossed binder covers and plain matching backs (the front frame embossed covers are available with or without die-cut windows. Instructions, which can be in written form or in software form provided on an enclosed computer disc, instruct the user on how to line up the first sheet of their presentation so that the information which they desire to be viewed through a diecut window lines up to their specifications. Alternatively, the binder covers will be available with no diecut window. Instead, perforated label sheets of custom sized labels can fit in the area of the embossed frame which has a solid background are provided. Packages of pocket folders are provided with perforated label sheets of custom sized labels to fit in the area of the embossed frame along with instructions in written form or on software provided on an enclosed computer disc that will instruct the user on how to line up their information to print on the label to fit their specifications. Packages of text sheets (for use as companion sheets for the inside information of the presentation or for use as stationary) are provided; and coordinating packages of business sized envelopes; and packages of coordinating card stock (for use in inkjet and laser printers) perforated for use as business cards are also provided. Additionally, text sheets will be available in business sized envelopes and business card stock for a complete corporate identity package that coordinates with a marketing brochure or presentation of multiple uses in a highly professional and competitive style. Similarly available will be packages of coordinating catalog envelopes. Symbols are printed on each label that will identify which text stocks to use with which binder covers and pocket folders.

In one version of the kiosk, a method using symbols will be used to identify a professional mix and match system. Different styles will be offered to support different types of businesses and uses. Enclosed in the packages of binder covers and pocket folders will be a piece that offers design solutions to creating professional presentations, i.e.: layout ideas. The same will be offered in presenting creative, professional layouts for stationary packages and a web site to refer to get even more ideas and access to professional design services for logos and logotypes. This creates a fool-proof way of supplying a professional presentation and corporate identity package for the home-based business, small business or divisions within large corporations that now share the same design challenges with budget and volume usage restraints, among other already described disadvantages to the current offering on the market.

The kiosk would be four sided:

Side One: Binder Covers (packaged with label sheets if there is no diecut in embossed framed area), Companion Text Sheets, Catalog Sized Envelopes. In this particular kiosk there are provided 4 cover options, 8 text options and 4 coordinating catalog envelopes (each having custom label sheets included in the package).

Side Two: Pocket Folders (packaged with label sheets), Companion Text Sheets, Catalog Sized Envelopes. In this particular kiosk there are provided 4 pocket folder options, 8 text options and 4 coordinating catalog envelopes (they would have custom label sheets included in the package).

Sides Three and Four: Text Sheets for Stationary, Business Size Envelopes, Business Card Stock . . . all coordinated for a complete corporate identity package.

The kiosk could be designed so that there are ends that jut outwards with additional display space that would support audio/video design videos, design samples and unique accessory items that will support the home based office . . . i.e.: unique round and square paper clips of multiple and coordinating colors, grommets and fasteners with usage suggestions and additional items designed for additional uses.

### Display Kiosk 2

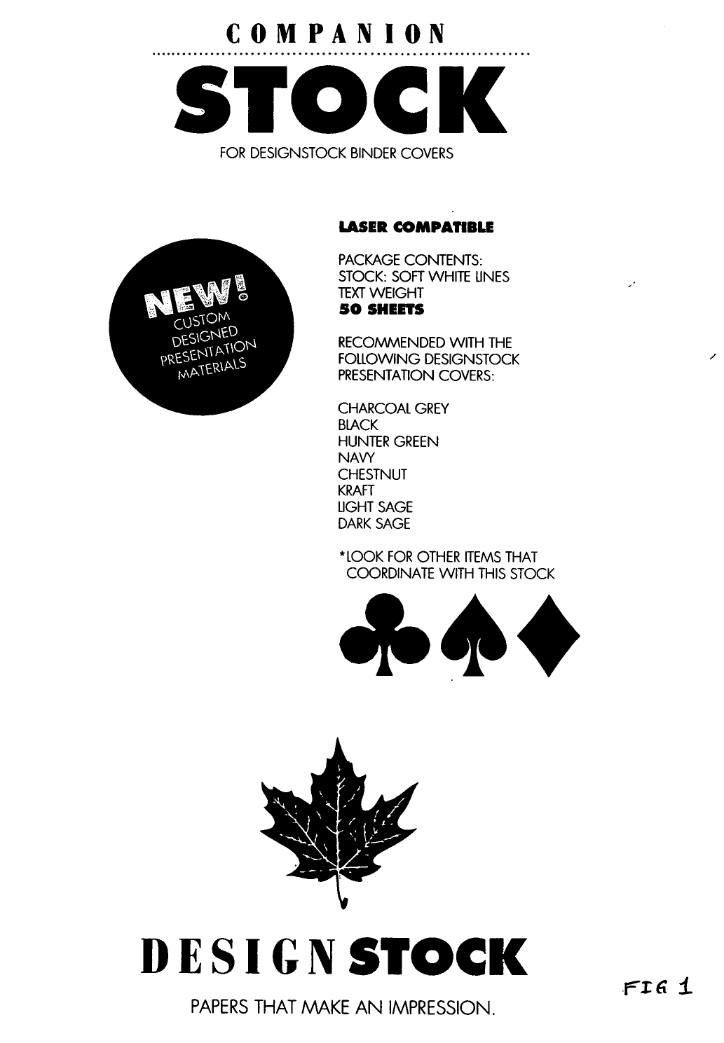

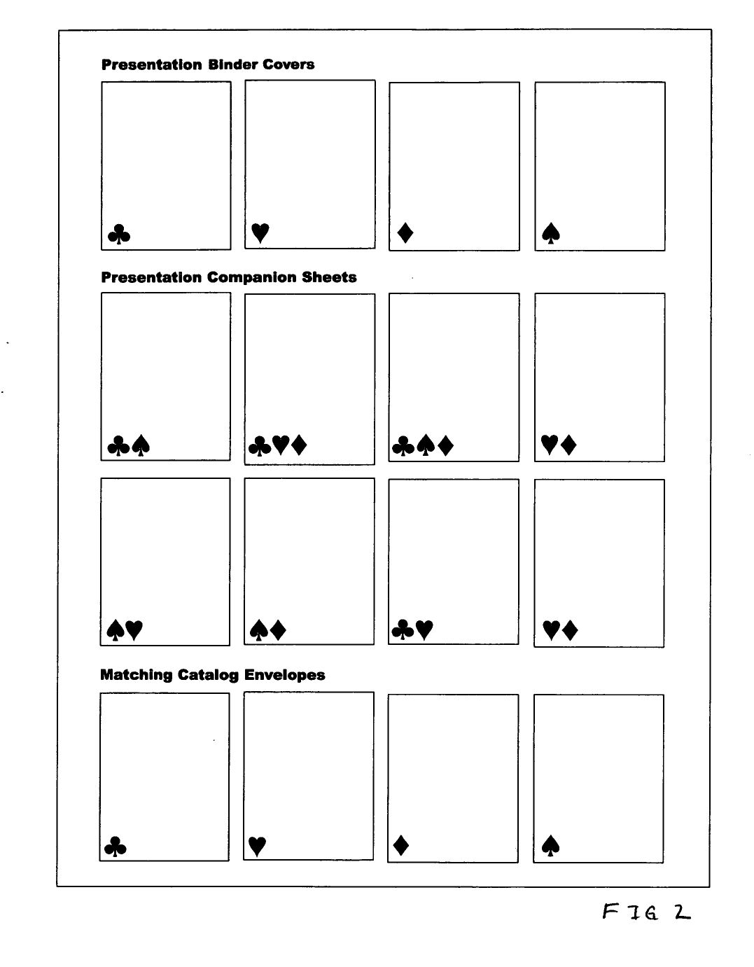

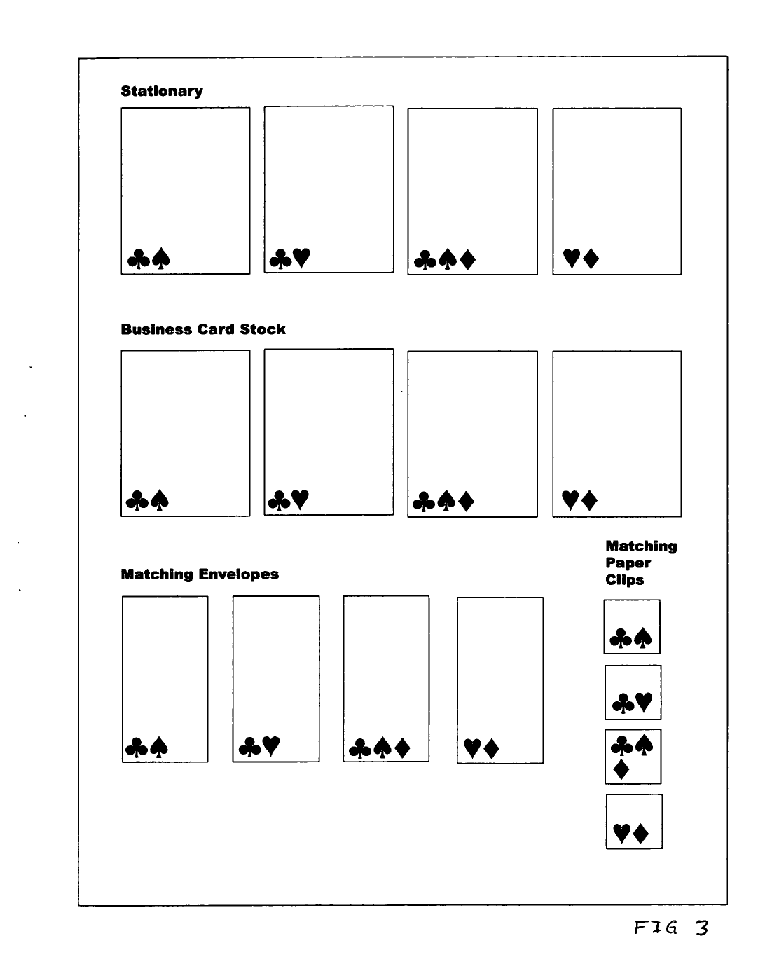

A display kiosk is established to have multiple bins containing presentation materials, such as Presentation Binder Covers, Presentation Companion Sheets, Matching Catalog Envelopes, Stationary, Business Card Stock, Matching Envelopes, and Matching Paper Clips. Within each group of presentation material, a variety of choices is available. Depending on the nature of the presentation material, the varying characteristic might be size, color, weight, surface finish or texture, among other characteristics. FIG. 1 depicts a cover front page of a particular selection of a package of Presentation Companion Sheets. As can be discerned, the cover sheet displays a variety of characteristic information about the content of the package. The cover sheet also displays a variety of recommend uses. Other packages of Presentation Companion Sheets are available, each different type being stocked in a separate bin. Similarly for each of the different types of presentation materials, a variety of choices increase the amount of information and recommendation for use for each type of presentation material and also requires coordination with the information and recommendations for the other types of presentation materials. Such creates an expansive matrix of information and recommendations which can become overwhelming. The kiosk of this example has two sides/walls of bins containing the variously listed presentation materials listed above. The arrangement of the bins relative to each other is depicted respectively in FIGS. 2 and 3 as they would be physically arranged on the kiosk sides/walls. FIG. 2 depicts the bin layout arrangement of one side of a kiosk using the present invention selling presentation materials, including packages of materials referred to in FIG. 1. FIG. 3 depicts the bin layout arrangement of another side of the same kiosk referred to in FIG. 2. For instance, in FIG. 2, there is depicted four rows of presentation materials. The top row contains Presentation Binder Covers, the next two rows below contain Presentation Companion Sheets, and the bottom row contains Matching Catalog Envelopes. The presentation materials are contained in number of materials packaged according to sameness and having a visible package cover sheet similar to that in FIG. 1, such as viewable through a window of the package or affixed to the top side of the package. In each rectangle of the bins depicted in the layouts of FIGS. 2 and 3 there are shown a black emblem which arbitrarily in this example are the well-known suits of a card deck, that is, spade, heart, diamond and club. Using the layout of FIGS. 2 and 3, the stocker of the presentation materials loads each bin in accord with the use of these emblems as a code of which item package is to be loaded. Alternatively, though less preferred, the stocker could place such items into the bins in an arbitrary manner. In either instance, the cover sheet of each package also contains the coded emblems, as can be seen in FIG. 1 in which the club, spade and diamond emblems are depicted. Packages of the material having the cover sheet of FIG. 1 would be placed in the bin depicted in the layout of FIG. 2 second row from top, third bin to the right. A user of the kiosk is instructed that a selection of presentation materials may be made from the various bins using the suit emblems to match compatibility of material characteristics. For example, a the package having the cover sheet in FIG. 1 can be matched for design purposes with the material in any other package bearing either a club emblem, spade emblem or diamond emblem. Therefore, in this particular case, using the cover sheet emblems, the user is guided to use any Presentation Binder Covers except that in the second bin, since it has a heart emblem. Same holds true for the Matching Catalog Envelopes. It is noted that any Matching Envelope can be selected for use with the particular Presentation Companion Sheets because, even though the second and fourth bins have a heart emblem, they also have a club and diamond emblem, respectively, indicating compatibility. While the guidance in this instance is provided by use of a cover sheet, the guidance could also be provided by placement of the guide codes elsewhere, such as a bin label etc. Guidance can also be provided other than merely by shape of a code emblem, but also by color etc.

What is claimed is:

1. A point-of-purchase system for selecting a presentation material set, said system comprising means for displaying two or more different package groups selected from a group comprising
a package group of one or more binder cover stock package(s),
a package group of one or more pocket folder package(s),
a package group of one or more text stock package(s) selected from companion stock package(s) and stationary package(s),
a package group of one or more envelope package(s) selected from standard envelope packages and customized packages, and
a package group of one or more label package(s) selected from standard label packages and customized label packages;
wherein at least one of said package groups comprises a selection of packages which respective media character of the contents differ,
and
each of said packages is associated with a code which enables the designer coordination of the media character of the content of such package with the media character of the content of another package.

2. The system of claim 1 wherein the media character comprises color, dimension, weight and/or texture.

3. The system of claim 1 wherein the media character comprises grid-set values to align a window, a label, an embossment, and/or a die-cut.

4. The system of claim 1 wherein the coordination of media character provides a variation of less than 5% in the media character of selected packages.

5. The system of claim 1 wherein the media character is printability.

10. A method of creating a guide to the selection of a set of products, said method comprising
displaying two or more different package groups selected from a group comprising
a package group of one or more binder cover stock package(s),
a package group of one or more pocket folder package(s),
a package group of one or more text stock package(s) selected from companion stock package(s) and stationary package(s),
a package group of one or more envelope package(s) selected from standard envelope packages and customized packages, and
a package group of one or more label package(s) selected from standard label packages and customized label packages;
wherein at least one of said package groups comprises a selection of individual packages which respective media character of the contents differ from that of other individual packages within the package group;
providing a code associated with each of said package; and
selecting two or more of said packages in accord with provided instructions for matching the respective codes on each selected package to coordinate the media characters of the contents of the selected package(s).
